(19) United States
(12) Patent Application Publication
(10) Pub. No.: US 2005/0193840 A1
(43) Pub. Date: Sep. 8, 2005

(54) Structure of engine starter equipped with planetary gear speed reducer

(75) Inventors: Kazuaki Murase, Kounan-shi (JP); Youichi Hasegawa, Kasugai-shi (JP); Sadayoshi Kajino, Nagoya (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/066,134

(22) Filed: Feb. 25, 2005

(30) Foreign Application Priority Data
Feb. 25, 2004 (JP) 2004-49266
Feb. 27, 2004 (JP) 2004-52709

(51) Int. Cl. F02N 1/00

(52) U.S. Cl. 74/7 E; 74/7 A

(57) ABSTRACT

A starter for automotive engines is provided which is equipped with a planetary gear speed reducer. The speed reducer works to reduce the speed of rotation of an electric motor and transmit it to an output shaft which is to be moved and joined to the engine through a pinion gear for starting the engine. The starter includes a thrust load sustaining mechanism made of a plate which works to sustain a thrust load arising from backward movement of the pinion gear after start-up of the engine, thereby blocking transmission of the thrust load to an armature shaft of an electric motor to avoid damage to the armature shaft.

### CROSS REFERENCE TO RELATED DOCUMENT

The present application claims the benefits of Japanese Patent Application No. 2004-49266 filed on Feb. 25, 2004, and No. 2004-52709 filed on Feb. 27, 2004, the disclosure of which is incorporated herein by reference.

### BACKGROUND OF THE INVENTION

1. Technical Field of the Invention

The present invention relates generally to a starter which may be employed in starting an automotive engine, and more particularly to an improved structure of such a starter equipped with a planetary gear speed reducer working to reduce the speed of rotation of an electric motor and transmit it to an output shaft for cranking the engine.

2. Background Art

Japanese Patent First Publication No. 58-214668 discloses a typical engine starter equipped with a planetary gear speed reducer. The starter includes a one-way clutch (also called an overrunning clutch) which has an outer in which support pins are installed to support planet gears rotatably and to which orbital motion of the planet gears is transmitted directly to transfer torque to an output shaft of the starter. The torque of the output shaft is transmitted to a pinion gear fitted on the output shaft slidably through a shift lever. The pinion gear is selectively brought into engagement with a ring gear to crank the engine.

After start-up of the engine, the pinion gear is returned backward through the shift lever along the output shaft and hits a wall provided on the output shaft. The impact arising from the hit is transmitted to the output shaft as thrust load. An allowable amount of backward movement of the output shaft is limited by a sun gear fitted on an armature shaft of the motor (or by a tip end of the armature shaft). Upon transmission of the thrust load to the output shaft, the output shaft collides at a rear end thereof with the sun gear, so that the thrust load is transmitted to the armature shaft.

The armature shaft has installed thereon a resinous member in which a plurality of conductive segments are press fit to constitute a commutator. The resinous member is lower in mechanical strength than metal. The transmission of the thrust load from the armature shaft to the resinous member may, therefore, result in lifting of one or some of the conductive segments or, in the worst case, in dislodgement thereof. In recent years, the motor has been reduced in size, so that its thermal capacity is decreased. This results in a decreased safety factor of the commutator in terms of the thrust load when the temperature is rising during operation of the motor. The structure of the starter is, therefore, sought which is strong enough to withstand the thrust load.

When the motor is deenergized, the sum of friction created between the sun gear and the rear end of the output shaft urged against the sun gear and friction created between the commutator and brushes pushed against the commutator by springs develops a braking force acting on inertial rotation of the armature. However, since the rear end of the output shaft pushed against the sun gear is smaller in diameter, the degree of braking force produced by the friction between the output shaft and the sun gear is small. The increase in wear of the brushes will result in decrease in spring pressure urging the brushes against the commutator, thus causing the degree of braking force produced by the friction between the brushes and the commutator to be decreased. Consequently, the time required for the inertial rotation of the armature to stop is prolonged as the wear of the bushes increases. This contributes to the possibility that if the starter has failed in starting the engine, a vehicle operator turns on the starter again in error before the inertial rotation of the armature stops completely. In such an event, the pinion gear is increased in speed during the inertial rotation of the armature, thus producing a great scale of impact shock upon engagement of the pinion gear with the ring gear, which causes damage to the starter.

### SUMMARY OF THE INVENTION

It is therefore a principal object of the invention to avoid the disadvantages of the prior art.

It is another object of the invention to provide a starter designed to avoid transmission of thrust load on an armature shaft of an electric motor upon returning of a pinion gear to an initial position thereof and/or to shorten the time required for the armature to stop completely.

According to one aspect of the invention, there is provided a starter which may be employed in starting an automotive engine. The starter comprises: (a) an electric motor including an armature with a commutator, the armature being energized to rotate an armature shaft; (b) an output shaft disposed coaxially with the armature shaft of the motor; (c) a planetary gear speed reducer designed to reduce a speed of rotation of the armature shaft through orbital motion of planet gears and to transmit torque of the armature shaft to the output shaft; (d) a pinion gear moving along a given path selectively in one of a first direction to engage a ring gear connected to an engine for transmitting the torque of the output shaft to the engine and a second direction to disengage from the ring gear; and (e) a thrust load sustaining mechanism working to sustain a thrust load arising from movement of the pinion gear in the second direction so as to block transmission of the thrust load to the armature shaft of the motor. This avoids damage to the commuator installed on the armature.

In the preferred mode of the invention, the thrust load sustaining mechanism is made of a partition plate which defines a motor chamber within which the motor is disposed and a speed reducer chamber within which the planetary gear speed reducer is disposed. The partition plate is so disposed as to hit the planet gears, support pins supporting the planet gears through gear bearings, or the gear bearings upon the movement of the pinion gear in the second direction to sustain the thrust load. The planet gears, the support pins, the gear bearings are located outwardly of a gear (e.g., a sun gear) fitted on the armature shaft in a radius direction thereof, thus causing frictional pressures developed by the hits of the planet gear, the support pins, or the gear bearings on the partition plate to create a greater degree of braking torque than that in the starter, as discussed in the introductory part of this application. The braking torque hardly changes with the wear of brushes of the motor, thus ensuring the braking ability for an extended period of time.

The thrust load sustaining mechanism may alternatively be made of a combination of a partition plate and a plate which is higher in surface hardness than the partition plate. The partition plate defines the motor chamber within which the motor is disposed and the speed reducer chamber within which the planetary gear speed reducer is disposed. The plate is disposed in the speed reducer chamber so as to experience a physical hit with the planet gears, the support pins supporting the planet gears through gear bearings, or the gear bearings upon the movement of the pinion gear in the second direction to sustain the thrust load. This structure eliminates the need for heat-treating the partition plate for hardening the surface thereof.

The plate may be placed in engagement with one of the partition plate and a selected part disposed around the plate and held thereby from rotating. This prevents the plate from rotating following rotational motion of the planet gears, the support pins, or the gear bearings, thereby producing a braking torque arising from friction between the plate and the planet gears, the support pins, or the gear bearings. The plate is exposed to the speed reducer chamber, therefore, the grease applied to gears of the speed reduction mechanism serves to ensure the adhesion of the plate to the partition plate, thus facilitating ease of assembling of the starter.

The partition plate may be made of a braking material having a high frictional resistance.

One of the planet gears, the support pins, and the gear bearings which hit against the partition plate upon the movement of the pinion gear in the second direction may be made of a sintered oil-containing material.

The output shaft may be slidable in an axial direction thereof. the starter may further include a one-way clutch working to transmit the rotation of the armature shaft reduced in speed by the planetary gear speed reducer to the output shaft. The one-way clutch includes a driving rotary outer, a driven rotary inner, torque-transmitting rollers interposed between the outer and the inner, and a stopper wall provided integrally with the outer. The stopper wall serves to hold the rollers from moving axially in the second direction and has the support pins installed therein. The plate is disposed so as to ensure a given gap between an end of the armature shaft and the stopper wall upon the physical hit with the planet gears, the support pins, or the gear bearings during the movement of the pinion gear in the second direction. The gap functions to block transmission of the thrust load to the armature, thus avoiding the damage to the commutator.

The stopper wall has formed therein through holes extending from a first surface to a second surface opposed to the first surface. Each of the through hole includes a press-fit hole section which is exposed to the first surface and within which one of the support pins is partially press fit and a hole section which leads from the press-fit hole section and is exposed to the second surface. The hole section has an inner diameter smaller than that of the press-fit hole section.

When the support pin is inserted into and press-fitted in the press-fit hole section, air is compressed therewithin, but escapes from the hole section to outside the stopper wall, thereby minimizing a reactive pressure resisting the advancement of the support pin to avoid a defective fit of the support pin in the press-fit hole section.

In a case where the press-fit hole second extends straight to the second surface of the stopper wall, when, for example, the support pins hit the partition plate many times, so that they are undesirably forced into the press-fit holes section, it results in an increased gap between the partition plate and the support pins. This leads to a decrease in the gap between the tip end of the armature shaft and the stopper wall created upon abutment of the support pins on the partition plate. In the worst case, the stopper wall abuts the tip end of the armature shaft, so that the thrust loads are transmitted to the armature shaft.

If the tip of the support pin is pushed out of the second surface of the stopper wall and exposed to a cam chamber in the outer, it may cause the roller to physically interfere with the support pin, thus resulting in locking of the one-way clutch.

The structure of the starter of this invention is designed to eliminate the above problems. Specifically, the hole section functions to define a maximum depth to which the support pin is allowed to be inserted and serves to ensure a given gap between the tip end of the armature shaft and the stopper wall when the support pins abut the partition plate and also to avoid the physical interference of the rollers with the support pins which may lead to the locking of the one-way clutch.

According to the second aspect of the invention, there is provided a production method for a starter equipped with a planetary gear speed reducer designed to reduce a speed of rotation of a motor through planet gears, which comprises the steps of: (a) preparing a planet gear supporting member which has press-fit holes; (b) press-fitting supporting pins into the press-fit holes of the planet gear supporting member; (c) heat-treating an assembly of the planet gear supporting member and the supporting pins to harden a surface of the assembly; and (d) fitting planet bears on the supporting pins.

After the support pins are forced into the press-fit holes of the planet gear supporting member, they are heat-treated as a whole. In other words, the support pins are press-fitted before the heat treatment, thus minimizing cracks incident to the planet gear supporting member upon the press-fitting of the support pins to ensure the stability of joints of the support pins to the planet gear supporting member. This eliminates the need required in the prior art for subjecting treatment such as anti-carbonization or annealing to the planet gear supporting member in order to protect the outer surface of the planet gear supporting member from the thermal treatment or for thickening the planet gear supporting member in order to remove a hardened surface after the planet gear supporting member is heat-treated, thus resulting in a decreased total amount of time consumed in producing the starter and also in decreased production costs as compared with conventional starters in which the support pins and the planet gear supporting member are heat-treated independently.

The support pins may be machined by, for example, cutting or forging independently of the planet gear supporting member, thus not encountering the problem of local stress staying in the support pins which would arise in a case where the support pins and the planet gear supporting member are formed integrally by the cold forging. The heat treatment of the assembly of the planet gear supporting member and the support pins, therefore, does not result in the inclination of the support pins and is effective to ensure the geometrical accuracy required by the support pins themselves and the assembly. This minimizes the wear of bearings in which the support pins are fitted or mechanical noises arising therefreom.

The heat-treating step is performed to shrink the press-fit holes inwardly and expand the supporting pins outwardly, thereby increasing the stability of joints of the supporting pins to the planet gear supporting member.

The heat-treating step may subject the assembly to one of carburizing and carbonitriding which diffuses carbon in the surface of the assembly. A difference in percentage of carbon contained in materials of the supporting pins and the planet gear supporting member before being heat-treated may be selected within a range which results in no cracks after the assembly is heat-treated.

The support pins may have a hardness before undergoing heat treatment which is selected to permit a degree of deformation of the support pins during press-fitting into the press-fit holes to fall within a given permissible range.

If the hardness of the support pins is undesirably low, the pressure to force the support pins into the press-fit holes may result in buckling of the support pins. This decreases clearance between the support pins and bearings in which the support pins are fitted, thus aggravating a difficulty in fitting the bearings on the support pins. In order to eliminate this problem, the hardness of the support pins is preferably selected to permit the degree of deformation of the support pins during insertion into the press-fit holes to fall within the permissible range which does not result in the buckling of the support pins. This also avoids a defective fit of the bearings on the support pines and a bias wear of the bearings.

According to the third aspect of the invention, there is provided a starter fabricated by the production method as set forth above.

The starter may further include a one-way clutch working to transmit the rotation of the motor reduced in speed by the planetary gear speed reducer to an output shaft. The planet gear supporting member may be provided integrally an outer that is a driving rotary member of the one-way clutch. The one-way clutch is a mechanism working to transmit the torque of the motor to the output shaft and usually heat-treated. The heat treatment of the planet gear supporting member may, therefore, be achieved simultaneously with that of the one-way clutch, thus resulting in decreases in production steps and costs.

The planet gear supporting member may alternatively provided integrally with the output shaft. The output shaft is usually heat-treated. The heat treatment of the planet gear supporting member may, therefore, be achieved simultaneously with that of the output shaft, thus resulting in decreases in production steps and costs.

Each of the press-fit holes may extend through a wall of the planet gear supporting member in a direction in which one of the supporting pin is forced into the press-fit hole. Specifically, the press-fit holes are through holes, thus causing the ends of the support pins placed within the press-fit holes to also undergo the heat treatment. This results in expansion of the ends of the support pins to enhance the strength of joints to the press-fit holes.

In a case where the press-fit holes are closed at an end thereof, air compressed within the press-fit holes by insertion of the support pins or machining oil staying in the press-fit holes is subjected to intense heat and expands during the heat treatment, which, in the worst case, causes the support pins to jump out of the press-fit holes. The press-fit holes of this invention is so formed as to extend through the wall of the planet gear supporting member, thus avoiding the above problem.

Further, the air compressed in the press-fit holes during the insertion of the support pins escapes to outside the planet gear supporting member, thereby minimizing a reactive pressure resisting the advancement of the support pin to avoid a defective fit of the support pin in the press-fit hole.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal cross sectional view which shows an internal structure of a starter according to the first embodiment of the invention;

FIG. 2 is a partially sectional view which shows a speed reduction mechanism and an one-way clutch of the starter of FIG. 1;

FIG. 3 is a partially sectional view which shows a speed reduction mechanism and an one-way clutch of a starter according to the second embodiment of the invention;

FIG. 4 is a partially sectional view which shows a speed reduction mechanism and an one-way clutch of a starter according to the third embodiment of the invention;

FIG. 5 is a longitudinal cross sectional view which shows an internal structure of a starter according to the fourth embodiment of the invention;

FIG. 6 is a partially sectional view which shows a speed reduction mechanism and an one-way clutch of a starter according to the fifth embodiment of the invention;

FIG. 7 is a partially sectional view which shows a carrier of a planetary gear speed reducer in which a support pin for a planet gear is press fit;

FIG. 8 is a partially sectional view which shows an assembly of a carrier and a support pin for a planet gear which is heat-treated to harden a surface of the assembly;

FIG. 9 is a partially sectional view which shows an internal structure of a one-way clutch of the starter of FIG. 6; and

FIG. 10 is a circuit diagram which shows a solenoid switch and an electric motor of the starter of FIG. 6.

### DESCRIPTION OF THE PREFERRED EMBODIMENTS

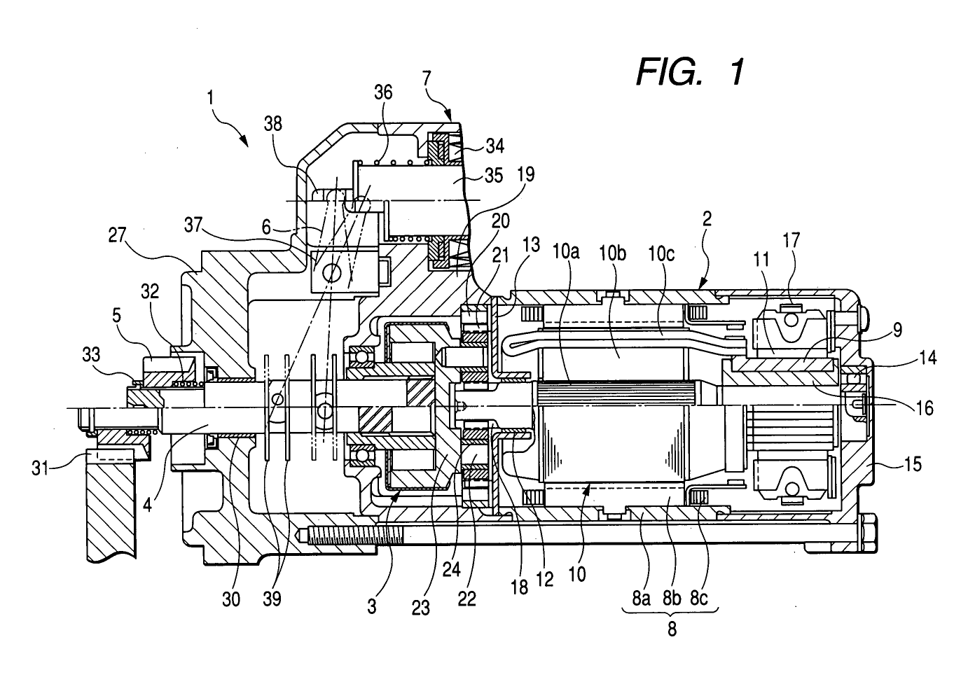

Referring to the drawings, wherein like reference numbers refer to like parts in several views, particularly to FIG. 1, there is shown a starter 1 according to the first embodiment of the invention which may be employed in starting an automotive engine.

The starter 1 consists essentially of an electric motor 2, a speed reduction mechanism, as will be described later in detail, an output shaft 4, a pinion gear 5, and a solenoid switch 7. An output of the motor 2 is reduced in speed by the speed reduction mechanism and transmitted to the output shaft 4 through a one-way clutch (also called an overrunning clutch) 3. The output shaft 4 has the pinion gear 5 fitted thereon. The solenoid switch 7 works to close main contacts (not shown) installed in a driver circuit of the motor 2 and advance the output shaft 4 in an axial direction thereof through a shift lever 6.

The motor 2 is a dc motor which includes a field system 8, an armature 10 with a commutator 9, and brushes 11 riding on the commutator 9. When the main contacts are closed by the solenoid valve 7, it will cause an electric current to be supplied from a storage battery (not shown) installed in the vehicle to energize the armature 10, so that it produces torque.

The field system 8 is made up of a yoke 8a working to form a magnetic circuit, a field pole 8b affixed to an inner periphery of the yoke 8a, and a field coil 8c wound around the field pole 8b. The field system 8 may alternatively be of a magnet type.

The armature 10 is made up of a rotary armature shaft 10a, an armature core 10b fitted on the armature shaft 10a, and an armature coil 10c wound around the armature core 10b. The armature shaft 10a is supported at an end by a partition plate 13 through a bearing 12 and at the other end by an end frame 15 through a ball bearing 14.

The commutator 9 is made up of a plurality of conductive segments arrayed in a cylindrical form on the periphery of the end of the armature shaft 10a through a resinous insulator 16. Each of the segments is joined electrically and mechanically with the armature coil 10c.

The brushes 11 are urged against the periphery of the commutator 9 by brush springs 17.

The speed reduction mechanism is implemented by a typical epicycle reduction gear train (also called a planetary gear speed reducer) made up of a sun gear 18, a ring-shaped internal gear 20, planet gears 21, and a carrier 23. The sun gear 18 is formed on the end of the armature shaft 10a. The internal gear 20 is retained fixedly by a center casing 19. The planet gears 21 are placed in mesh with the gears 18 and 20. The carrier 23 bears the planet gears 21 through support pins 22. The speed reduction mechanism works to reduce a rotational speed of the armature 10 to an orbital speed of the planet gears 21.

Each of the planet gears 21 is supported rotataby by one of the support pins 22 through a gear bearing 24. The support pins 22 are press fit in the carrier 23.

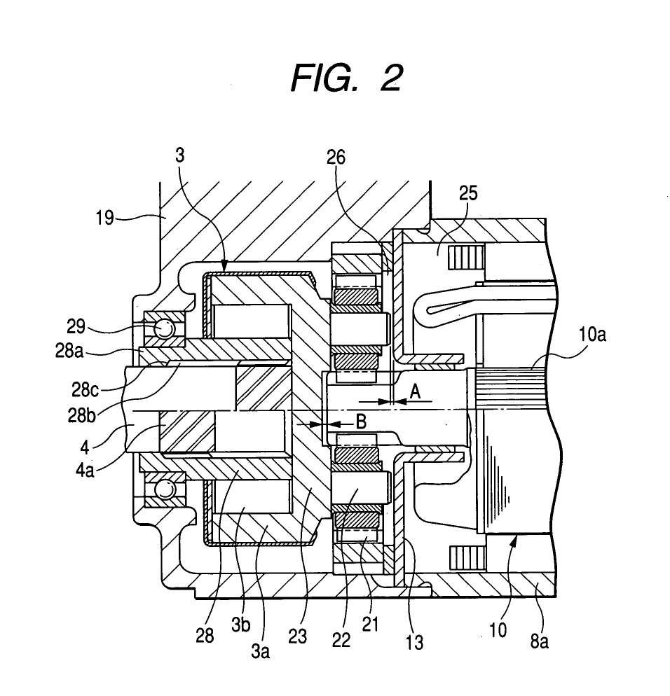

The partition plate 13, as clearly illustrated in FIG. 2, defines a motor chamber 25 in which the armature 10 is disposed and a speed reducer chamber 26 in which the speed reduction mechanism is disposed in order to avoid entrance of powder dust arising from the wear of the brushes 11 into the speed reducer chamber 26. The partition plate 13 is made of a donut plate and a center cylinder extending integrally from an inner edge of the donut plate. The donut plate has an outer periphery nipped between the yoke 8a of the motor 2 and the center casing 19. The center cylinder, as can be seen in FIG. 1, has fitted therein the bearing 12 which supports the end of the armature shaft 10a rotatably.

The partition plate 13 also serves as a thrust bearing which sustains hits of the tips of the support pins 22 of the planet gears 21 when the output shaft 4 is returned by the shift lever 6 toward the motor 2 (i.e., the right, as viewed in the drawing), thereby alleviating a thrust load acting on the output shaft 4. The support pins 22 of the planet gears 21 abut the wall of the partition plate 13 and move in a circumferential direction of the internal gear 20 in sliding contact with the partition plate 13. The partition plate 13 may therefore be subjected to heat treatment such as carburizing in order to increate the surface hardness thereof.

If the amount by which the support pins 22 are allowed to move to the partition plate 13 (i.e., the gap or distance between the support pins 22 and the partition plate 13) is, as indicated in FIG. 2, defined as A, and the gap or the distance between the carrier 23 and the armature shaft 10a when the support pins 22 are the distance A from the partition plate 13 is defined as B, a relation of A<B is met. This secures spacing between the carrier 23 and the armature shaft 10a upon abutment of the tips of the support pins 22 on the partition plate 13, thus avoiding a direct hit of the carrier 23 on the armature shaft 10a. The carrier 23, as clearly shown in FIG. 2, has formed in an end surface thereof a central recess which faces the tip of the armature shaft 10a, thereby ensuring the distance B.

Referring back to FIG. 1, the center casing 19 is interposed between the yoke 8a and a front housing 27 to embrace the one-way clutch 3 and the speed reducing mechanism.

The one-way clutch 3 is, as clearly shown in FIG. 2, made up of an outer 3a, a tube 28, and rollers 3b. The outer 3a is formed integrally with the carrier 23. The tube 28 defines an inner within the outer 3a. The rollers 3b are disposed within cam chambers (not shown) formed in an inner periphery of the outer 3a and work to transmit the torque from the outer 3a that is a driving clutch rotor to the tube 28 that is a driven clutch follower. The carrier 23 is interposed between the armature shaft 10a and the output shaft 4 and function as a stopper to hold the rollers 3b from moving toward the motor 2 (i.e., the right in the drawing).

The tube 28 has formed on an end thereof a bearing mount surface 28a on which a ball bearing 29 is fitted and is supported by the center casing 19 rotatably through the ball bearing 29.

The tube 28 has an internal helical spline 28b, as shown in FIG. 2, formed on the inner wall thereof. The internal helical spline 28b extends from the end of the tube 28 to the underneath of the bearing mount surface 28a. The tube 28 has an inner edge 28c projecting inwardly thereof which works as a stopper to stop an axial movement of the output shaft 4 to outside the tube 28.

The output shaft 4 is disposed coaxially with the armature shaft 10a of the motor 2. The output shaft 4 is supported at the left end thereof, as viewed in FIG. 1, by the front housing 27 through the bearing 30 and has formed on the right end thereof an external helical spline 4a meshing with the internal helical spline 28b of the tube 28 so that the output shaft 4 may rotate along with the tube 28 and move relative to the tube 28 in the axial direction thereof. In FIG. 1, an upper side above a longitudinal center line of the output shaft 4 illustrates the starter 1 at rest, while a lower side illustrates the starter 1 in motion where the output shaft 4 has advanced into engagement of the pinion gear 5 with the ring gear 31 of the engine.

The pinion gear 5 is jointed to the head of the output shaft 4 (i.e., a portion projecting from the bearing 30) in a spline fashion to be rotatable in unison with the output shaft 4. The pinion gear 5 is also urged frontward (i.e., the left in FIG. 1) by a pinion spring 32 disposed between the pinion 5 and the output shaft 4 into abutment with a collar 33 installed on the tip of the output shaft 4. The amount of backward movement of the pinion 5 relative to the output shaft 4 is determined by the amount by which the spring 32 is compressed fully.

The solenoid switch 7 includes a coil 34 excited upon closing of a starter switch (not shown) of the vehicle, a plunger 35 slidable within the coil 34, and a return spring 36. When the coil 34 is energized by the starter switch, it will cause the plunger 35 to be attracted frontward (i.e., the rightward, as viewed in FIG. 1) against a spring pressure of the return spring 36 to advance the output shaft 4 through the shift lever 6. Alternatively, when the coil 34 is deenergized, it will cause the plunger 35 to be moved backward by the return spring 36 to return the output shaft 4 through the shift lever 6. The solenoid switch 7 also works to open or close the main contacts of the driver circuit of the motor 2, as described above, according to movement of the plunger 35.

The shift lever 6 is supported by a lever holder 37 to be swingable. The lever holder 37 is secured to the center casing 19. The shift lever 6 has an upper portion, as viewed in FIG. 1, joined to a hook 38 retained by the plunger 35 and a lower portion nipped between washers 39 fitted on the output shaft 4, thereby transferring the movement of the plunger 35 to the output shaft 4.

In FIG. 1, an upper side above a longitudinal center line of the plunger 35 illustrates for the case where the solenoid switch 7 (i.e., the coil 34) is deenegized, while a lower side illustrates for the case where the solenoid switch 7 is energized.

In operation of the starter 1, when the starter switch is closed to energized the coil 34 of the solenoid switch 7, it will cause the plunger 35 to be attracted to advance the output shaft 4 away from the motor 2 through the shift lever 6. When the pinion gear 5 on the output shaft 4 meshes with the ring gear 31 of the engine completely, the solenoid switch 7 closes the main contacts of the driver circuit of the motor 2, so that the armature 10 produces torque. Alternatively, when the pinion gear 5 hits the ring gear 31 without meshing with the ring gear 31, it will cause only the output shaft 4 to advance further, while compressing the pinion spring 32, so that the pinion gear 5 rotates and slides backward on the output shaft 4. When the pinion gear 5 rotates following the advancement of the output shaft 4 until it is allowed to mesh with the ring gear 31, it is urged or advanced by the reactive pressure produced by the pinion spring 32 into mesh with the ring gear 31. The solenoid switch 7 then closes the main contacts of the driver circuit of the motor 2, so that the armature 10 produces torque.

Upon completion of the meshing of the pinion gear 5 with the ring gear 31, the torque is transmitted from the pinion gear 5 to the ring gear 31 to crank the engine.

After the start-up of the engine, the starter switch is opened to deenergize the coil 34. This causes the plunger 35 to be attracted backward by the return spring 36. The solenoid switch 7 then opens the main contacts of the motor drive circuit to cut the supply of power to the armature 10.

Additionally, the backward movement of the plunger 35 causes the output shaft 4 to be moved by the shift lever 6 toward the motor 2, so that the rear end of the output shaft 4 hits on the carrier 23, thereby moving the carrier 23 rightward, as viewed in FIG. 1, so that the tips of the support pins 22 retained in the carrier 23 abut the partition plate 13.

When the main contacts of the motor drive circuit are opened to stop supplying the power to the armature 10 of the motor 2, the friction developed between the brushes 11 and the commutator 9 and between the support pins 22 and the partition plate 13 creates a drag on the inertia rotation of the armature 10, so that the armature 10 decelerates gradually and comes to rest.

As apparent from the above discussion, the starter 1 is designed to have the partition plate 13 working to sustain thrust loads transmitted from the output shaft 4 to the carrier 23 which arise from mechanical hits of the tips of the support pin 22 retained by the carrier 23 on the partition plate 13. Upon the hits of the tips of the support pins 22 on the partition plate 13, the gap is, as described above, ensured between the end of the armature shaft 10a and the carrier 23, thus blocking transmission of the thrust loads from the carrier 23 to the armature shaft 10a. No mechanical stress is, thus, applied to the commutator 9 of the armature 10, thus avoiding the breakage of the commutator 9 such as lifting or dislodgement of the segments).

Upon the hit of the rear end of the output shaft 4 on the wall of the carrier 23, a resulting mechanical impact is transmitted to the support pins 22 which are located outwardly of the sun gear 18 of the armature shaft 10a in a radius direction of the sun gear 18, thus causing frictional pressures developed by the hits of the support pins 22 on the partition plate 13 to create a greater degree of braking torque acting on the support pins 22. The braking torque hardly changes with the wear of the brushes 11, thus ensuring the braking ability of the support pins 22 for an extended period of time.

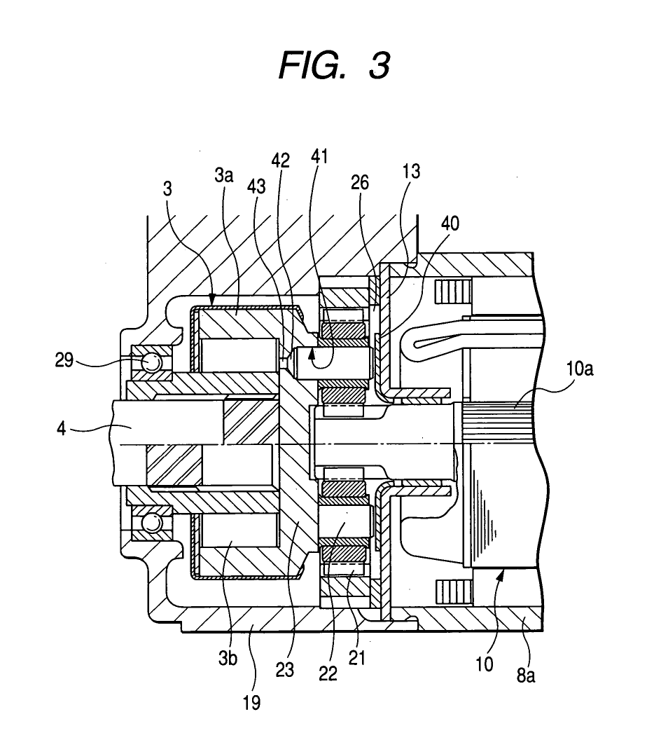

FIG. 3 shows the speed reduction mechanism and periphery thereof the starter 1 according to the second embodiment of the invention.

The starter 1 has an annular plate 40 disposed on the outer wall of the partition plate 13 within the speed reducer chamber 26 so that the tips of the support pins 22 may abut directly on the plate 40. Specifically, the plate 40 works to sustain the thrust loads exerted by the support pins 22. The plate 40 is greater in surface hardness than the partition plate 13 and held directly by the partition plate from rotating. This eliminates the need for thermal treatment of the partition plate 13, thus permitting the partition plate 13 to be made of an untreated material, resulting in decreased costs of the starter 1.

The plate 40 is held by the partition plate 13 from rotating following orbital motion of the support pins 22 around the armature shaft 10a, so that the frictional pressures between the support pins 22 and the plate 40 produces a sufficient amount of braking torque acting on the support pins 22. The plate 40 may alternatively be joined to and held by a component part of the starter 1 other than the partition plate 13 (e.g., the center casing 19) from rotating.

The plate 40 is affixed to the outer surface of the partition plate 13 exposed to the speed reducer chamber 26, therefore, the grease applied to the gears of the speed reduction mechanism serves to ensure the adhesion of the plate 40 to the partition plate 13, thus facilitating ease of assembling of the starter 1.

The plate 40 may be made of a typical brake material with a higher coefficient of friction. Use of such a material results in an increased braking torque, thus decreasing the time required to stop the armature 10.

The carrier 23, as clearly shown in FIG. 3, has through holes in which the support pins 22 are secured. Each of the through holes extends in the axial direction of the starter 1 and is made up of a press-fit hole 41, a tapered hole 42, and a smaller-diameter hole 43. The press-fit holes 41 has a length leading to the outer surface of the carrier 23 and an inner diameter required to establish an interference fit of the support pin 22 therein. The tapered hole 42 has an inner diameter which decreases from the end of the press-fit hole 41 to the inner wall of the carrier 23. The small-diameter hole 43 extends from the tapered hole 42 to the inner wall of the carrier 23.

When the support pin 22 is inserted into and press-fitted in the press-fit hole 41 of the carrier 23, air is compressed within the through hole, but escapes from the small-diameter hole 43 to outside the carrier 23, thereby minimizing a reactive pressure resisting the advancement of the support pin 22 to avoid a defective fit of the support pin 22 in the press-fit hole 41.

The tapered hole 42 serves as a stopper to define a depth which allows the support pin 22 to be inserted into the press-fit hole 41. In a case where the press-fit hole 41 extends straight to the back surface of the carrier 23, when the support pins 22 hit the partition plate 13 many times, so that they are undesirably forced into the press-fit holes 41, it results in an increased gap between the partition plate 13 and the support pins 22. This leads to a decrease in the gap between the tip end of the armature shaft 10a and the carrier 23 created upon abutment of the support pins 22 on the partition plate 13. In the worst case, the carrier 23 abuts the tip end of the armature shaft 10a, so that the thrust loads are transmitted to the armature shaft 10a.

If the tip of the support pin 22 is pushed out of the front end wall of the carrier 23 and exposed to the cam chamber in the outer 3a, it may cause the roller 3b to physically interfere with the support pin 22, thus resulting in locking of the one-way clutch 3.

The structure of this embodiment is designed to eliminate the above problems. Specifically, the tapered hole 42 formed at the bottom of the press-fit hole 41 defines a maximum depth to which the support pin 22 is allowed to be inserted and serves to ensure a given gap between the tip end of the armature shaft 10a and the carrier 23 when the support pin 22 abuts the partition plate 13 and also to avoid the physical interference of the roller 3b with the support pin 22 which may lead to the locking of the one-way clutch.

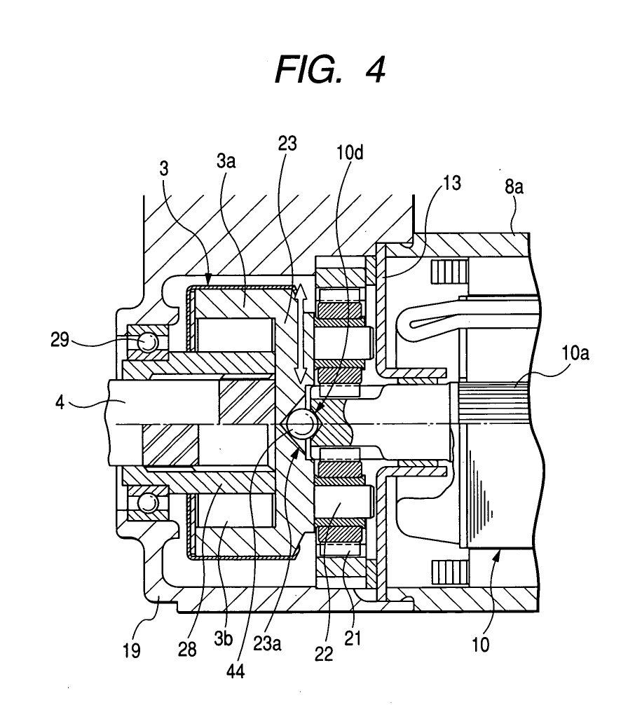

FIG. 4 shows the speed reduction mechanism and periphery thereof the starter 1 according to the third embodiment of the invention.

The carrier 23 has a cone-shaped tapered recess 23a from in the center of the rear end wall thereof. Similarly, the armature shaft 10a has a cone-shaped tapered recess 10d formed in the center of the front end thereof in alignment with the tapered recess 23a of the carrier 23 along the axis of the starter 1. A ball 44 is interposed between the tapered recesses 23a and 10d. This structure works to center the outer 3a of the one-way clutch 3 to the armature shaft 10a. At the overrun of the one-way clutch 3 caused by transmission of the engine torque the pinion gear 5 after the start-up of the engine, the rollers 3b are usually lifted from the tube 28 (i.e., the inner), which allows the outer 3a to be moved eccentrically in a radius direction, as indicated by an arrow in the drawing. The ball 44, however, works to hold the outer 3a from moving in the radius direction and keeps the outer 3a in alignment with the armature shaft 10a.

Similar to the above embodiments, when the output shaft 4 is returned toward the motor 2, the support pins 22 abut the partition plate 13 (or the plate 40), thereby avoiding transmission of the thrust loads to the armature shaft 10a.

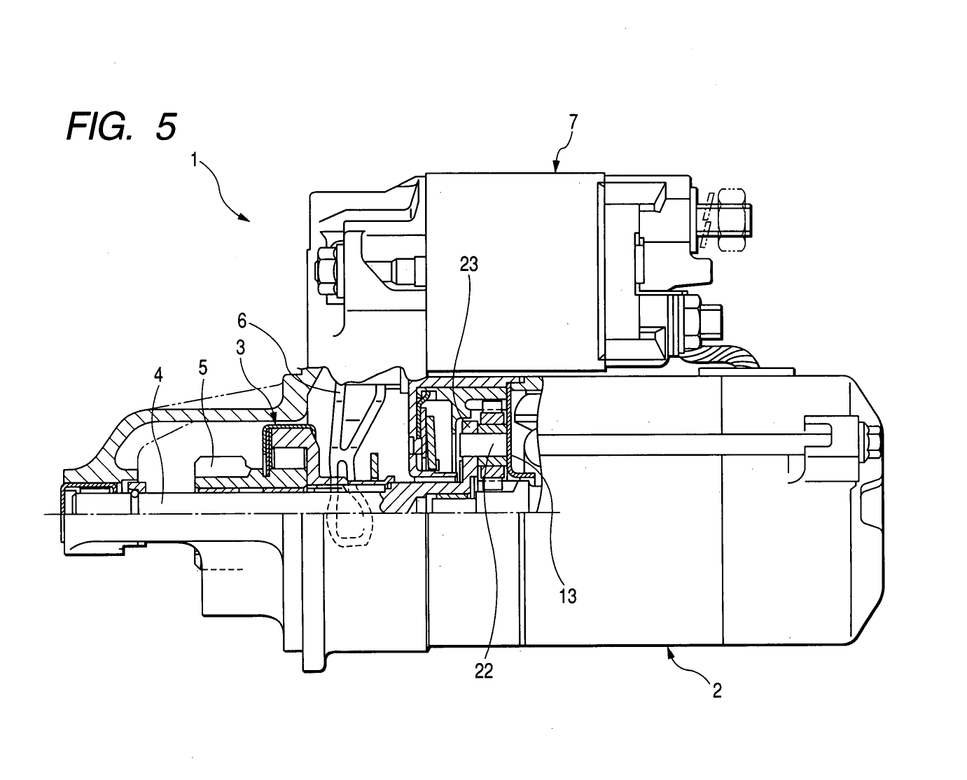

FIG. 5 shows the starter 1 according to the fourth embodiment of the invention.

The starter 1 has the carrier 23 formed integrally with the rear end of the output shaft 4. The pinion gear 5 and the one-way clutch 3 are disposed on the output shaft 4 slidably. Specifically, the pinion gear 5 and the one-way clutch 3 are moved along the output shaft 4 by the shift lever 6 to engage or disengage from the ring gear 31 (not shown). Other arrangements are identical with those in the above embodiments, and explanation thereof in detail will be omitted here.

The starter 1 of each of the above embodiments may alternatively be designed to have the bearings 24 or the planet gears 21 abut the partition plate 13 or the plate 40 instead of the support pins 22 to avoid the transmission of thrust loads to the armature shaft 10a.

Further, parts to abut the partition plate 13 or the plate 40 may be made of a sintered oil-containing material such as an oilless bearing in order to minimize the friction between themselves and the partition plate 13 or the plate 40 created upon rotation of the parts relative to the partition plate 13 or the plate 40.

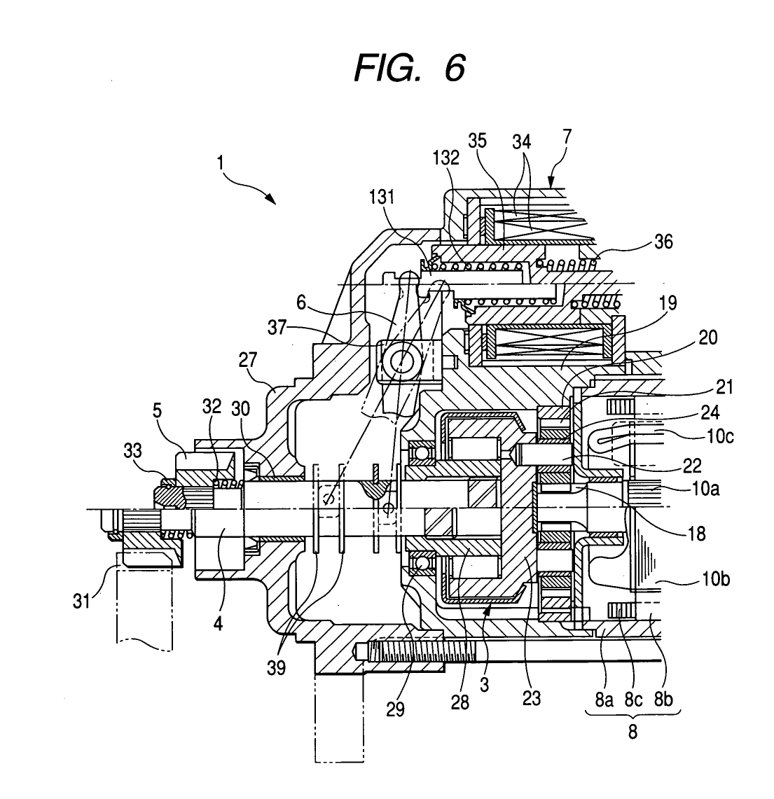

FIG. 6 is a partially sectional view which shows the starter 1 according to the fifth embodiment of the invention.

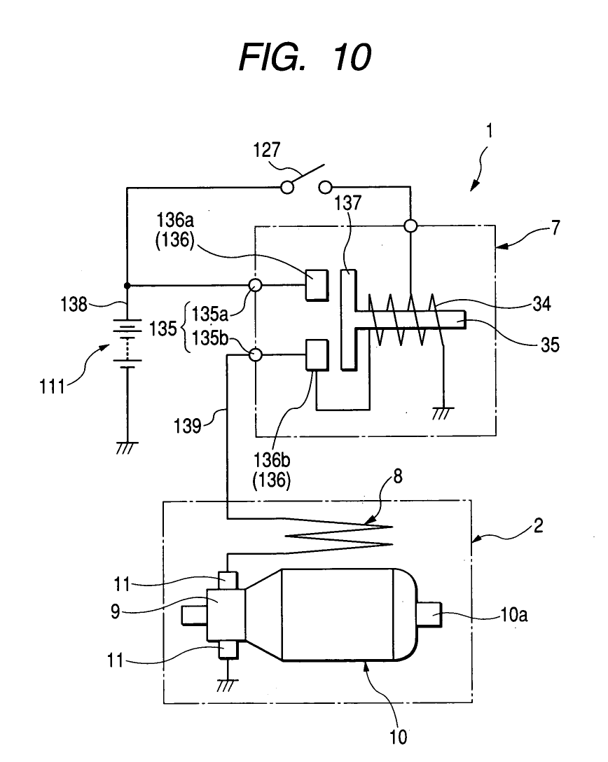

The starter 1 consists essentially of the electric motor 2 (see FIG. 10), a speed reduction mechanism (also called a planetary gear speed reducer), as will be described later in detail, the output shaft 4, the pinion gear 5, and the solenoid switch 7. An output of the motor 2 is reduced in speed by the speed reduction mechanism and transmitted to the output shaft 4 through the one-way clutch 3. The output shaft 4 has the pinion gear 5 fitted thereon. The solenoid switch 7 works to close main contacts, as will be described later in detail, arranged in a driver circuit of the motor 2 and advance the output shaft 4 in an axial direction thereof through the shift lever 6.

The motor 2 is a dc motor which includes, as clearly shown in FIG. 10, the field system 8, the armature 10 with the commutator 9, and brushes 11 riding on the commutator 9. When the main contacts of the motor driver circuit are closed by the solenoid valve 7, it will cause an electric current to be supplied from a storage battery (not shown) installed in the vehicle to energize the armature 10, so that it produces torque.

The field system 8 is, as illustrated in FIG. 6, made up of the yoke 8a working to form a magnetic circuit, the field pole 8b affixed to an inner periphery of the yoke 8a, and the field coil 8c wound around the field pole 8b. The field system 8 may alternatively be of a magnet type.

The armature 10 is made up of the rotary armature shaft 10a, the armature core 10b fitted on the armature shaft 10a, and the armature coil 10c wound around the armature core 10b. The commutator 9 is made up of a plurality of conductive segments joined mechanically and electrically with the armature coil 10c.

The speed reduction mechanism is implemented by a typical epicycle reduction gear made up of the sun gear 18, a ring-shaped internal gear 20, and planet gears 21. The sun gear 18 is formed on the end of the armature shaft 10a. The internal gear 20 is retained fixedly by the center casing 19. The planet gears 21 are placed in mesh with the gears 18 and 20. The speed reduction mechanism works to reduce the speed of rotation of the armature 10 to the speed of orbital motion of the planet gears 21.

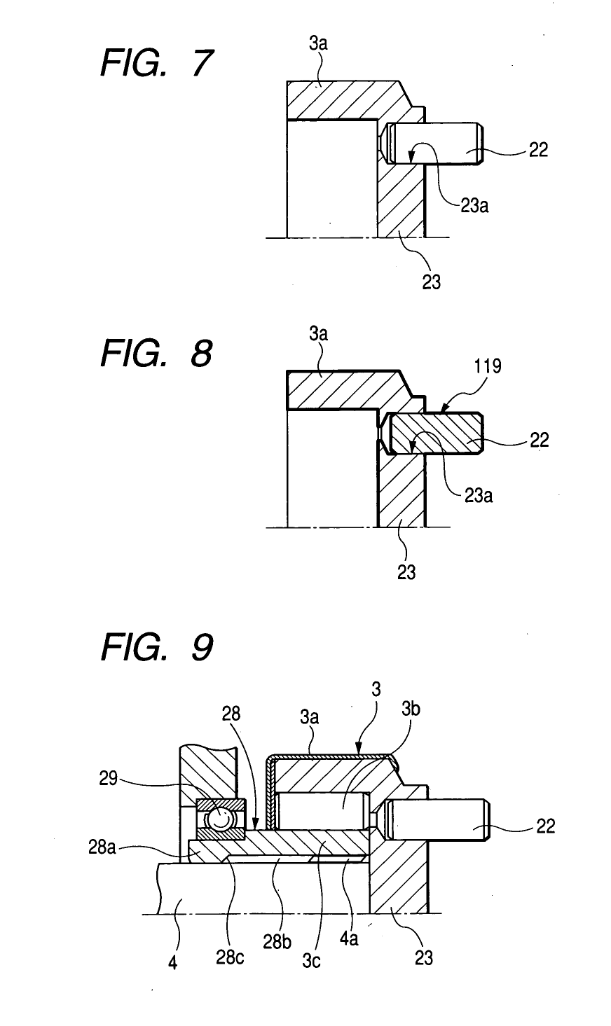

Each of the planet gears 21 is supported rotataby by the support pin 22 through the gear bearing 24. The support pin 22 is, as clearly shown in FIG. 7, press fit in a press-fit hole 23a formed in the carrier 23.

The carrier 23 is formed, as can be seen from FIG. 7, integrally with the outer 3a of the one-way clutch 3. After the support pins 22 are forced into the press fit holes 23a, the carrier 23 is subjected to thermal treatment such as carburizing or carbonitriding to form a hardened layer 119, as shown in FIG. 8, over the outer 3a, the carrier 23, and exposed portions of the support pins 22.

Each of the press-fit holes 23a extends through the wall of the carrier 23 in a direction in which one of the support pins 22 is forced. Each of the press-fit holes 23a includes a cylindrical hole and a tapered hole. The cylindrical hole extends from the outer surface of the carrier 23 to a given depth and has a uniform diameter. The tapered hole extends from the bottom of the cylindrical hole to the inner surface of the carrier 23 and has a diameter decreasing toward the inner surface of the carrier 23. The carburizing gas is fed into the press-fit holes 18a from the tapered holes to subject the thermal treatment to end surfaces of the support pins 22.

A difference in carbon percentage between the carrier 23 (including the outer 3a) and the support pins 22 is selected within a range which results in no cracks after the thermal treatment.

The center casing 19 is interposed between the yoke 8a and the front housing 27 to embrace the one-way clutch 3 and the speed reducing mechanism.

The one-way clutch 3 is, as clearly shown in FIG. 9, made up of the outer 3a, the tube 28, and the rollers 3b. The outer 3a is formed integrally with the carrier 23. The tube 28 defines the inner 3c within the outer 3a. The rollers 3b are disposed within wedge-shaped cam chambers (not shown) formed in an inner periphery of the outer 3a and work to transmit the torque from the outer 3a that is a driving clutch rotor to the tube 28 that is a driven clutch follower.

The tube 28 has formed on an end thereof the bearing mount surface 28a on which the ball bearing 29 is fitted and is supported by the center casing 19 rotatably through the ball bearing 29.

The tube 28 has the internal helical spline 28b formed on the inner wall thereof. The internal helical spline 28b extends from the end of the tube 28 to the underneath of the bearing mount surface 28a. The tube 28 has the inner edge 28c projecting inwardly thereof which works as a stopper to stop an axial movement of the output shaft 4 to outside the tube 28.

The output shaft 4 is supported at the left end thereof, as viewed in FIG. 6, by the front housing 27 through the bearing 30 and has formed on the right end thereof the external helical spline 4a meshing with the internal helical spline 28b of the tube 28 so that the output shaft 4 may rotate along with the tube 28 and move relative to the tube 28 in the axial direction thereof.

In FIG. 6, an upper side above a longitudinal center line of the output shaft 4 illustrates the starter 1 at rest, while a lower side illustrates the starter 1 in motion where the output shaft 4 has advanced into engagement of the pinion gear 5 with the ring gear 31 of the engine.

The pinion gear 5 is jointed to the head of the output shaft 4 (i.e., a portion projecting from the bearing 30) in a spline fashion to be rotatable in unison with the output shaft 4. The pinion gear 5 is also urged frontward (i.e., the left in FIG. 6) by the pinion spring 32 disposed between the pinion 5 and the output shaft 4 into abutment with the collar 33 installed on the tip of the output shaft 4. The amount of backward movement of the pinion 5 relative to the output shaft 4 is determined by the amount by which the spring 32 is compressed fully.

The solenoid switch 7, as clearly shown in FIGS. 6 and 10, includes the coil 34 excited by power supplied from the battery 111 upon closing of the starter switch 127, the plunger 35 slidable within the coil 34, the return spring 36, the hook 131, and the drive spring 132. When the coil 34 is energized by the starter switch 127, it will produce a magnetic attraction to attract the plunger 35 frontward (i.e., the rightward, as viewed in FIG. 6) against a spring pressure of the return spring 36 to advance the output shaft 4 through the shift lever 6. Alternatively, when the coil 34 is deenergized, it will cause the plunger 35 to be moved backward by the return spring 36 to return the output shaft 4 through the shift lever 6. The hook 131 is disposed within the plunger 35 and has a head which projects from the end of the plunger 35 and to which an upper end of the shift lever 6 is joined. The drive spring 132 is wound around the hook 131 within the plunger 35.

The shift lever 6 is supported by the lever holder 37 to be swingable. The lever holder 37 is secured to the center casing 19. The shift lever 6 has a lower end nipped between washers 39 fitted on the output shaft 4, thereby transferring the movement of the plunger 35 to the output shaft 4.

In FIG. 6, an upper side above a longitudinal center line of the plunger 35 illustrates for the case where the solenoid switch 7 (i.e., the coil 34) is deenegized, while a lower side illustrates for the case where the solenoid switch 7 is energized.

The main contacts of the motor driver circuit, as described above, are implemented by a pair of stationary contacts 136 (136a, 136b) and a movable contact 137. The stationary contact 136a is connected to the external terminal 135a of the switch 7 to which a plus terminal of the battery 111 is joined through the battery cable 138. The stationary contact 136b is connected to the external terminal 135b to which the field system 8 of the motor 2 is joined through the motor lead 139. The stationary contacts 136a and 136b are secured to a contact cover (not shown) and mechanically and electrically joined to the external terminals 135a and 135b within the contact cover. When the movable contact 137 is brought into contact with the stationary contacts 136a and 136b, it will cause the electric power to be supplied from the battery 111 to the motor 8 to energize the armature 10.

In operation of the starter 1, when the starter switch 127 is closed, the coil 34 of the solenoid switch 7 is energized. This will cause the plunger 35 to be attracted to advance the output shaft 4 away from the motor 2 through the shift lever 6. When the pinion gear 5 on the output shaft 4 meshes with the ring gear 31 of the engine completely, the solenoid switch 7 closes the main contacts, that is, it makes an electrical connection of the movable contact 137 with the stationary contacts 136a and 136b, so that the armature 10 produces torque.

Alternatively, when the pinion gear 5 hits the ring gear 31 without meshing with the ring gear 31, it will cause only the output shaft 4 to advance further, while compressing the pinion spring 32, so that the pinion gear 5 rotates and slides backward on the output shaft 4. When the pinion gear 5 rotates following the advancement of the output shaft 4 until it is allowed to mesh with the ring gear 31, the pinion gear 5 is urged or advanced by the reactive pressure produced by the pinion spring 32 into mesh with the ring gear 31. The solenoid switch 7 then makes the electrical connection of the movable contact 137 with the stationary contacts 136a and 136b, so that the armature 10 produces torque.

If the pinion 5 has failed in meshing with the ring gear 31, but the main contacts are subsequently closed, the armature 10 produces the torque to rotate the output shaft 4. When the output shaft 4 rotates until the pinion gear 5 is allowed to mesh with the ring gear 31, it is urged or advanced by the sum of reactive pressures produced by the pinion spring 32 and the drive spring 132 into mesh with the ring gear 31.

Upon completion of the meshing of the pinion gear 5 with the ring gear 31, the torque is transmitted from the pinion gear 5 to the ring gear 31 to crank the engine.

After the start-up of the engine, the starter switch 127 is opened to deenergize the coil 34. This causes the plunger 35 to be attracted backward by the return spring 36. The solenoid switch 7 then opens the main contacts 136 to cut the supply of power to the armature 10.

Additionally, the backward movement of the plunger 35 causes the output shaft 4 to be moved by the shift lever 6 toward the motor 2. The rear end of the output shaft 4 then hits on the inner wall of the carrier 23 and stops.

As apparent from the above discussion, the starter 1 of the fifth embodiment includes the planetary gear speed reducer designed to reduce the speed of rotation of the motor 2 through orbital motion of the planet gears 15. The planet gear speed reducer, as described above, includes the support pins 22 supporting the planet gears 21 rotatably and the carrier 23 in which the support pins 22 are press fit. The press-fitting of the support pins 22 is achieved by forcing the support pins 22 into the press-fit holes 23a formed in the carrier 23. After completion of the installation of the support pins 22 in the carrier 23, the assembly is surface-hardened through, for example, thermal treatment as a whole to form the hardened layer 119 extending cover the outer 3a, the carrier 23, and exposed portions of the support pins 22.

Interfaces of the inner wall of each of the press-fit holes 23a and a corresponding one of the support pins 22 are not surface-hardened, thus ensuring the stability of a joint therebetween without breakages or damages to the interfaces.

The carrier 23, as described above, also serves as a part of the one-way clutch 3 (i.e., the outer 3a in this embodiment) which forms cam surfaces on which the rollers 3b ride. The hardened layer 119, as clearly shown in FIG. 8, extends over the cam surfaces (i.e., the inner wall of the carrier 23) to provide a given degree of hardness to the cam surfaces. The carrier 23 of this embodiment is made up of a hollow cylindrical portion and a bottom. The cylindrical portion functions as the outer 3a of the one-way clutch 3. The bottom carries the support pins 22 fixedly and may be smaller in diameter than the cylindrical portion.

The support pins 22 do not reach the cylindrical portion of the carrier 23 and are placed, as can be seen from FIG. 9, inside a circular array of the rollers 3b of the one-way clutch 3 slightly in the radius direction of the carrier 23.

The press-fit holes 23a may extend through the bottom of the carrier 23. Each of the press-fit holes 23a consists of a large-diameter portion whose inner wall is contoured to achieve a press-fit of one of the support pins 22 and a small-diameter portion. The large-diameter portion is located on the side of the planetary gear speed reducer, while the small-diameter portion is located on the side of the one-way clutch 3. The support pins 22 are disposed away from the part (i.e., the outer 3a) of the carrier 23 that is one of components of the one-way clutch 3.

The starter 1 of the fifth embodiment has the advantages as discussed below.

After the support pins 22 are forced into the press-fit holes 23a of the carrier 23, they are, as described above, heat-treated as a whole. In other words, the support pins 22 are press-fitted in the carrier 23 before the heat treatment, thus minimizing cracks incident to the carrier 23 upon the press-fitting of the support pins 22 to ensure the stability of joints of the support pins 22 to the carrier 23. This eliminates the need required in the prior art for subjecting treatment such as anti-carbonization or annealing to the carrier 23 in order to protect the outer surface of the carrier 23 from the thermal treatment or for thickening the carrier 23 in order to remove a hardened surface after the carrier 23 is heat-treated, thus resulting in a decreased total amount of time consumed in producing the starter 1 and also in decreased production costs as compared with conventional starters in which the support pins 22 and the carrier 23 are heat-treated independently.

In order to decrease manufacturing processes of the starter 1, the support pins 22 and the carrier 23 may be formed integrally by the cold forging, but however, the support pins 22 and the carrier 23 are required to be shaped and positioned accurately. The cold forging usually does not meet such a requirement. This is because the cold forging results in local stress on the support pins 22 depending upon a flow of material of the support pins 22 during the cold forging, which is alleviated by the thermal treatment, but may result in inclination of the support pins 22, which does not meet geometrical accuracy required in the assembly of the carrier 23 and the support pins 22.

The support pins 22 of the fifth embodiment are machined by, for example, cutting or forging independently of the carrier 23, thus not encountering the problem of the local stress staying in the support pins 22. The thermal treatment of the assembly of the carrier 23 and the support pins 22, therefore, does not result in the inclination of the support pins 22 and is effective to ensure the geometrical accuracy required by the support pins 22 themselves and the assembly of the carrier 23 and the support pins 22. This minimizes the wear of the bearings 24 in which the support pins 22 are fitted or mechanical noises arising therefreom.

The formation of the hardened layer 119 in which carbon is diffused results in changes in compositions of the carrier 23 and the support pins 22, so that the press-fit holes 23a of the carrier 23 shrink, while the support pins 22 expands, thus resulting in an increased interference between the press-fit holes 23a and the support pins 22 to increase the strength of joints thereof.

The hardened layer 119 also extends, as clearly illustrated in FIG. 8, over the tips of the support pins 22 fitted in the press-fit holes 23a, thereby resulting in expansion of the tips of the support pins 22 which will increase the strength of fixation of the support pins 22 in the press-fit holes 23a. This permits a length of the support pins 22 fitting in the press-fit holes 23a to be decreased, which also allows the overall length of the starter 1 to be decreased.

In a case where the press-fit holes 23a are closed on the inner wall of the carrier 23, air compressed within the press-fit holes 23a by insertion of the support pins 22 or machining oil staying in the press-fit holes 23a is subjected to intense heat and expands during the thermal treatment, which, in the worst case, causes the support pins 22 to jump out of the press-fit holes 23a. The press-fit holes 23a of this embodiment are so formed as to extend through the wall of the carrier 23, thus avoiding the above problem.

Further, the air compressed in the press-fit holes 23a during the insertion of the support pins 22 escapes from the tapered holes to outside the carrier 23, thereby minimizing a reactive pressure resisting the advancement of the support pin 22 to avoid a defective fit of the support pin 22 in the press-fit hole 23a.

The support pins 22 may be made to have a hardness before undergoing the thermal treatment which permits a degree of deformation of the support pins 22 during insertion into the press-fit holes 23a to fall within a given permissible range. If the hardness of the support pins 22 is undesirably low, the pressure to force the support pins 22 into the press-fit holes 23a may result in buckling of the support pins 22. This decreases clearance between the support pins 22 and the bearings 24, thus aggravating a difficulty in fitting the bearings 24 on the support pins 22. In order to eliminate this problem, the hardness of the support pins 22 is preferably selected to permit the degree of deformation of the support pins 22 during insertion into the press-fit holes 23a to fall within the permissible range which does not result in the buckling of the support pins 22. This also avoids a defective fit of the bearings 24 on the support pines 22 and a bias wear of the bearings 24.

While the carrier 23 also functions as the outer 3a of the one-way clutch 3, it may be, as illustrated in FIG. 5, provided integrally on the output shaft 4. This is suitable for the structure of the starter 1 in which the one-way clutch 3 slides along the output shaft 4 together with the pinion 5.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

1. A starter for an engine comprising:
an electric motor including an armature with a commutator, the armature being energized to rotate an armature shaft;
an output shaft disposed coaxially with the armature shaft of said motor;
a planetary gear speed reducer designed to reduce a speed of rotation of the armature shaft through orbital motion of planet gears and to transmit torque of the armature shaft to said output shaft;
a pinion gear moving along a given path selectively in one of a first direction to engage a ring gear connected to an engine for transmitting the torque of the output shaft to the engine and a second direction to disengage from the ring gear; and
a thrust load sustaining mechanism working to sustain a thrust load arising from movement of said pinion gear in the second direction so as to block transmission of the thrust load to the armature shaft of said motor.

2. A starter as set forth in claim 1, wherein said thrust load sustaining mechanism is made of a partition plate which defines a motor chamber within which said motor is disposed and a speed reducer chamber within which said planetary gear speed reducer is disposed, the partition plate being so disposed as to hit the planet gears, support pins supporting the planet gears through gear bearings, or the gear bearings upon the movement of said pinion gear in the second direction to sustain the thrust load.

3. A starter as set forth in claim 1, wherein said thrust load sustaining mechanism is made of a partition plate and a plate which is higher in surface hardness than the partition plate, the partition plate defining a motor chamber within which said motor is disposed and a speed reducer chamber within which said planetary gear speed reducer is disposed, the plate being disposed in the speed reducer chamber so as to experience a physical hit with the planet gears, support pins supporting the planet gears through gear bearings, or the gear bearings upon the movement of said pinion gear in the second direction to sustain the thrust load.

4. A starter as set forth in claim 3, wherein the plate is placed in engagement with one of the partition plate and a selected part disposed around the plate and held thereby from rotating.

5. A starter as set forth in claim 3, wherein the partition plate is made of a braking material having a high frictional resistance.

6. A starter as set forth in claim 2, wherein one of the planet gears, the support pins, and the gear bearings which hit against the partition plate upon the movement of said pinion gear in the second direction is made of a sintered oil-containing material.

7. A starter as set forth in claim 2, wherein said output shaft is slidable in an axial direction thereof, and further comprising a one-way clutch working to transmit the rotation of the armature shaft reduced in speed by said planetary gear speed reducer to said output shaft, said one-way clutch including a driving rotary outer, a driven rotary inner, torque-transmitting rollers interposed between the outer and the inner, and a stopper wall provided integrally with the outer, the stopper wall serving to hold the rollers from moving axially in the second direction and having the support pins installed therein, and wherein the plate being disposed so as to ensure a given gap between an end of the armature shaft and the stopper wall upon the physical hit with the planet gears, support pins supporting the planet gears through gear bearings, or the gear bearings during the movement of said pinion gear in the second direction.

8. A starter as set forth in claim 7, wherein the stopper wall has formed therein through holes extending from a first surface to a second surface opposed to the first surface, each of the through hole including a press-fit hole section which is exposed to the first surface and within which one of the support pins is partially press fit and a hole section which leads from the press-fit hole section and is exposed to the second surface, the hole section having an inner diameter smaller than that of the press-fit hole section.

9. A production method for a starter equipped with a planetary gear speed reducer designed to reduce a speed of rotation of a motor through planet gears, comprising:
preparing a planet gear supporting member which has press-fit holes;
press-fitting supporting pins into the press-fit holes of the planet gear supporting member;
heat-treating an assembly of the planet gear supporting member and the supporting pins to harden a surface of the assembly; and
fitting planet bears on the supporting pins.

10. A production method as set forth in claim 9, wherein said heat-treating step is performed to shrink the press-fit holes inwardly and expand the supporting pins outwardly.

11. A production method as set forth in claim 9, wherein the heat-treating step subjects the assembly to one of carburizing and carbonitriding which diffuses carbon in the surface of the assembly, and wherein a difference in percentage of carbon contained in materials of the supporting pins and the planet gear supporting member before being heat-treated is selected within a range which results in no cracks after the assembly is heat-treated.

12. A production method as set forth in claim 9, wherein the support pins has a hardness before undergoing heat treatment which is selected to permit a degree of deformation of the support pins during press-fitting into the press-fit holes to fall within a given permissible range.

13. A starter produced by the method as set forth in claim 9.

14. A starter as set forth in claim 13, further comprising a one-way clutch working to transmit the rotation of the motor reduced in speed by the planetary gear speed reducer to an output shaft, and wherein the planet gear supporting member is provided integrally an outer that is a driving rotary member of the one-way clutch.

15. A starter as set forth in claim 13, further comprising a one-way clutch working to transmit the rotation of the motor reduced in speed by the planetary gear speed reducer to an output shaft, and wherein the planet gear supporting member is provided integrally with the output shaft.

16. A starter as set forth in claim 13, wherein each of the press-fit holes extends through a wall of the planet gear supporting member in a direction in which one of the supporting pin is forced into the press-fit hole.

17. A starter produced by the method as set forth in claim 10.

18. A starter produced by the method as set forth in claim 11.

19. A starter produced by the method as set forth in claim 12.
